(19) United States
(12) Patent Application Publication
(10) Pub. No.: US 2007/0216104 A1
(43) Pub. Date: Sep. 20, 2007

(54) SEAL

(76) Inventor: Ralf Salameh, Gondelsheim (DE)

Correspondence Address: Robert L Stearns;Dickinson Wright, 38525 Woodward Avenue, Bloomfield Hills, MI, 48304-2970, US

(21) Appl. No.: 11/571,126

(22) PCT Filed: May 27, 2005
(86) PCT No.: PCT/DE05/00954

§ 371 Date: Dec. 21, 2006

(30) Foreign Application Priority Data
Jun. 22, 2004 (DE) 10 2004 030 203.0

(51) Int. Cl. F02F 11/00

(52) U.S. Cl. 277/313

(57) ABSTRACT

A seal comprising a carrier frame which is provided with fixing holes and which contains partial areas extending at an angle in relation to each other and joined to each other in a single piece, at least one radially sealable and one axially sealable through opening in at least one of the partial areas and at least one other partial area which contains at least one axially active seal area, wherein the axially active seal areas of individual partial areas are provided on the same side of the carrier frame opposite the sealable component openings.

The present invention concerns a seal for the concurrent radial and axial sealing of component openings.

Static seal systems belong to the general state-of-the-art and are generally intended to seal component openings against penetration by dirt, liquids or similar materials. Seal systems are frequently required which can seal off component openings while concurrently also providing a seal for component openings mounted on another level, to accept actuators, sensors, plug receptacles or other similar objects, so that special requirements here are to be placed on the overall seal, with respect to its individual components.

This invention is based on the task of sealing axial openings in a component, and in the same manner integrating at least one implementation of a seal, whereby a concurrent seal can be accomplished axial to the component, and radial to the part to be passed through.

This assignment is accomplished by a seal in accordance with Patent claim 1.

Advantageous further developments of the object of this invention are provided in the subordinate claims.

The carrier frame can be made of metal or plastic, and incorporates at least one bend, to allow the shape to conform to the component geometry. To configure a defined pressing, spacer mounts are to be formed in the area of the mounting holes, using the material of the carrier frame. To avoid tipping movement, the carrier frame is equipped with indentations running outside of the effective axial sealing area. This ensures an exact seal split limit even above the area of the bend. In addition to this, specific depressions in the carrier frame ensure adequate stiffness.

Onto this carrier frame two seal areas are sprayed onto the component side, which close off the component openings in an axial direction. These are advantageously sprayed from the bottom onto the carrier frame and close off the component openings. In the area of the penetration, for example, for motor placements, sensors, or for plug receptacles for electrical components, an axially working seal area adjoins the component on the one side, and on the other side is provided with at least one radial aligned seal bead for the penetrated component. The two axial-working seal areas are linked with each other on the one side of the flow channels, and run into the radial-working seal area, so that spraying is not required to be in multiple points, but much rather the entire seal geometry can be produced in one work process.

The mounting holes by means of which the carrier frame is attached to the component are advantageously formed as oval slots so that a centering alignment can occur on the component, prior to the screws being drawn down tightly.

Varying elastomer materials can be used, based on the application case. As needed various elastomer materials can be used on one single carrier frame, if this is required for the materials to be sealed.

The object of this invention is preferably to be used where the sealing of surfaces is necessary, where they do not lie on one level alignment. These could be, for example, a valve cap of internal combustion machines or similar items.

The object of this invention is represented by means of an execution example in the diagram, and is described as follows. It shows:

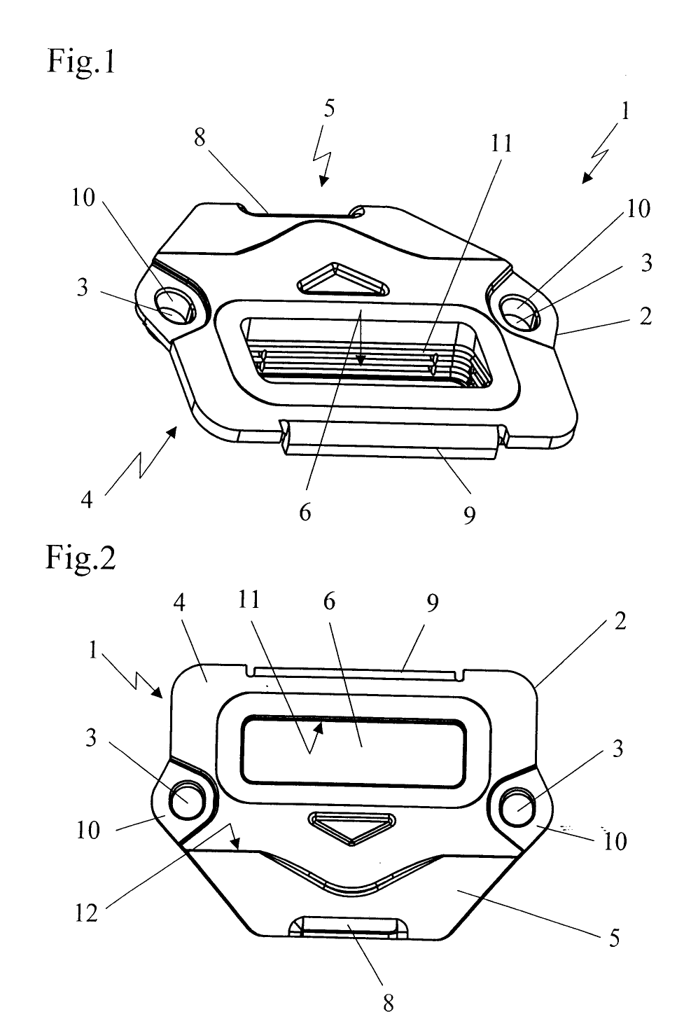

FIG. 1 Perspective representation of a seal as per this invention

FIG. 2 Seal in accordance with FIG. 1, top view

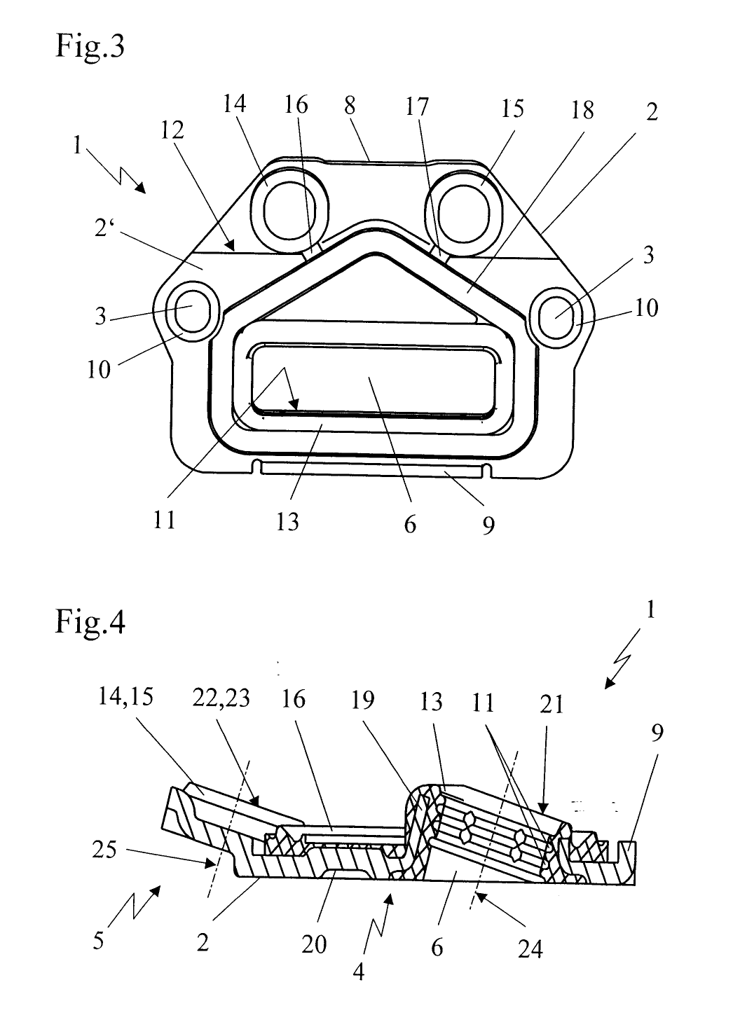

FIG. 3 Seal in accordance with FIG. 1, from below

FIG. 4 Cross-section in accordance with FIG. 1

FIG. 1 depicts a seal according to the invention in a perspective representation. The seal 1 in this example includes a metallic carrier frame 2, which exhibits slotted mounting holes 3, and has sub-sections 4 and 5, contained in one unit, but at an angle to each other. In sub-section 4 an open passage 6 is provided. The sub-sections 4 and 5 are equipped with indentations 8 and 9. A separation mount 10 is formed into the material of the carrier frame 1 in the area of the mounting holes 3, extending in the direction of the indentations 8 and 9. Because not all of the seal areas are recognizable in this perspective representation, these elements are described in more detail in the following sections.

FIGS. 2 and 3 show seal 1 in accordance with FIG. 1 from above (FIG. 2) and from below (FIG. 3). The carrier frame 2 is recognizable, as are the mounting holes 3 with the separation mount 10, the open passage 6, as well as the indentations 8 and 9. In FIG. 2 the open passage 6 is seen to be surrounded by at least one circumferential seal bead 11.

The open passage 6 represented in this example in a rectangular format is located in sub-section 4 of the carrier frame 2. A bend point is defined at reference point 12, so that the sub-section 5 lays at a predeterminable angle corresponding to the geometry of the not-further-represented component to be sealed relative to sub-section 4.

FIG. 3 shows the seal 1 from above. The axial working seal areas 13, 14, and 15 are visible, which are in a work relationship to flow channels 16, 17, and 18, representing additional seal areas as needed. With the axially working seal areas 13, 14, and 15 on the same Page 2 of the carrier frame 2, aligned in differing levels, the component-provided openings can be sealed where the axially working seal areas 14 and 15 close the relevant openings, while the pass-through opening 6 in the carrier frame 2 serves to allow the pass through of the plug of an electrical connection. Here also the radial working seal area is observable in the form of a circumferential seal bead 11, which lies in a sealing position against the other side of the corresponding surface of the plug, which is not represented here.

FIG. 4 shows a cross-section through the seal 1 in accordance with FIG. 1. The carrier frame 2 is represented, having at its disposal a horizontally aligned sub-section 4 and a sub-section 5, running at an angle. The pass-through opening 6 incorporates a formed area 19 which also runs under a predeterminable angle to the horizontal plane of the sub-section 4. In this cross-section it is noticeable that the radially working seal area comprises multiple axially stacked, radially working seal beads 11, which (not shown here) seal onto the to-be-passed-through device, possibly a plug, for example. The seal beads 11 encompass the not-further-represented opening in the component for the plug, while the axially working seal areas 14 and 15 seal off the opposing component opening provided on another level. These opening could be for example service access openings for adjustment work or something similar. Under reference point 16 the flow channels between the axially working seal areas 13, 14 and 15 are addressed.

In this cross-section the indentation 9 is noticeable, as well as stamped area 20, the stiffener for the carrier frame 2 being visible. The axially working seal areas 13, 14 and 15 run along the component-side in seal lips 21, 22 and 23. The sub-sections 4 and 5 are represented displaced in this example, so that the center line 24 of the pass-through opening 6 runs approximately parallel to the center line 25 of the statically working seal areas 14 and 15.

1-10. (canceled)

11. A seal assembly comprising a carrier frame having at least a first sub-section and a second sub-section which lie at an angle relative to one another, said at least first sub-section including at least one radially working seal area and at least one axially working seal area and a pass through opening, said at least second sub-section having at least one axially working seal area provided on the same side of said carrier frame as said at least one axially working seal area of said at least first sub-section.

12. The assembly of claim 11, wherein the pass through opening is arranged at an angle relative to a plane of said at least first sub-section in which said opening is formed.

13. The assembly of claim 11 sub-section wherein said at least one axially working seal area of said at least first sub-section is joined directly to said at least one radially working seal area of said at least first sub-section.

14. The assembly of claim 11 wherein said at least one radially working seal area includes at least one circumferential bead.

15. The assembly of claim 11 wherein said at least one axially working seal areas of said at least first and second sub-sections are at least partially in a working relationship with one another.

16. The assembly of claim 11 wherein said seal areas comprise spray-on regions of seal material.

17. The assembly of claim 11, wherein said at least axially working seal areas of said at least first and second sub-sections have associated center lines that are essentially parallel to one another.

18. The assembly of claim 11 including separation mounts disposed adjacent at least a pair of mounting holes of said carrier frame.

19. The assembly of claim 11 wherein said carrier frame includes at least one indentation disposed outside of said at least one axially working seal area adjacent an edge of said carrier frame.

20. The assembly of claim 11 wherein said carrier frame comprises a part of a lid seal of a valve cap of an internal combustion engine.
